(19) United States
(12) Patent Application Publication
(10) Pub. No.: US 2009/0301015 A1
(43) Pub. Date: Dec. 10, 2009

(54) Metal siding construction

(75) Inventor: Walter Brian Simms, Calhoun, GA (US)

Correspondence Address: WALTER BRIAN SIMMS, 541 CARPENTER ROAD NE, CALHOUN, GA, 30701, US

(73) Assignee: Simms Professional Craftsman Inc., Calhoun, GA (US)

(21) Appl. No.: 12/454,159

(22) Filed: May 14, 2009

Related U.S. Application Data
(60) Provisional application No. 61/130,842, filed on Jun. 4, 2008.

(51) Int. Cl. B44F 9/02

(52) U.S. Cl. 52/313

(57) ABSTRACT

An improved article of manufacture for Metal Siding, which can be formed into or painted to have the texture and appearance of raised grain which has the colors and appearance of weathered, rough sawn, or hand hewn wood.

### CROSS REFERENCE TO RELATED APPLICATIONS

This is based on the provisional application for patent Ser. No. 61/130,842, filed Jun. 4, 2008, titled Old Wood Metal Siding.

### FIELD OF THE INVENTION

1. Field of the Invention

This patent relates to Metal siding not of the typical architectural design, but to give the siding an appearance of wooden, board and batten siding. More particularly, this patent relates to an improved look for metal siding, which appears to be more realistic to the look of natural wood siding. Old barn wood is just one example of the desired result for this invention.

2. Description of the Related Art

Our search results did not yield anything along the same design goals as this present invention involves.

Conventional metal siding has a smooth finish with formed arching ribs placed in the longitudinal axis yielding strength and rigidity for the panels. This architectural design has been the most prominent on the market with little else to choose from. With this invention, customers will have the ability to construct a building that looks as though it has been built from wood and appears to be older than it actually is.

While prior art forms have been useful for their particular purpose, none have an appearance of old wood siding, which substantially limits the overall look of a building once completed. These conventional siding panels have been described as architectural siding panels and are only distinguished from each other by the difference in color and not for their varying textural appearances.

Thus, it is an objective of the present invention to provide a metal siding, which resembles old wood, is more rigid when stamped or embossed, and to also provide the flexibility of offering different type grain characteristics, color combinations and trim pieces to give an old wood look to metal siding.

### SUMMARY OF THE INVENTION

This invention relates to construction materials, and more particularly to an article of manufacture for metal siding construction. By having wood grain painted, stamped or formed in any other manner found to produce said wood grain affect, a metal siding can be produced to give a building the appearance of an old wood siding structure.

Batten strips maybe formed along the vertical axis, following a predetermined pattern to further replicate vertical plank siding. These batten strips can be extended out from the surface or recessed as in a reverse board and batten type construction.

The painted, etched or screened use of a wood grain pattern can result in the same appearance as a raised grain affect and can even have a stained finish look.

This invention is different from conventional industrial or architectural siding due to their lack of dimension in texture and the uniform placement of identical ribs along the length of the sheet. A texture with dimension is created with the use of a wood grain affect and by forming batten strips at a combination of panel widths within the sheet the uniform pattern is replaced with a look that is similar to that of real wood siding.

### DETAILED DESCRIPTION OF INVENTION

Turning to the drawings, the siding can be made by various different techniques used to create the appearance of real wood. The photo in FIG. 1 shows a stamped technique in which castings were made from rubber polymers being poured onto a weathered wood surface and then once these molds cured a hard and durable plastic polymer resin was cast into this mold to duplicate the features as a negative mold of the wood surface. A hydraulic press was then used to form a light gauge metal into an exact replica of the original wooden planks including the batten strip ribs.

The photo in FIG. 2 shows a piece of light gauge metal that was painted with a yellow exterior grade Latex house paint. Burgundy paint was then smeared on at random with a rag to create variations within the surface. A screen image made by a local T-shirt manufacturer duplicating the wood grain features was then screened onto the painted metal surface with a Black flat finish exterior grade latex paint.

The drawing in FIG. 3 shows the variation of having raised or lowered batten strips and their random placement as panel widths. These batten strips create greater rigidity in the siding by placing them along the longitudinal axis, in which they act as stiffening reinforcement for the siding.

The varying processes of manufacture for this siding can be realized by anyone skilled in the arts as an item that can be created by using different techniques, all of which will make the siding appear to be made of wood.

Other objects and advantages will become apparent from the following descriptions, which are taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a stamped section of light gauge steel that shows the detail of the wood grain and knot characteristics similar to that of old weathered wood. This process would require pressure to emboss the image onto the metal, similar to that in which the forming process requires.

FIG. 2 is a printed image of a screening technique common to the T-shirt screening process. This is a simple way of transposing an image of wood grains and other characteristics of wood to metal siding in a repetitive and high-speed manner.

FIG. 3 is a plan view of the siding that shows the variation in having raised or reversed strips of batten and their random placement as panels.

FIGS. 3a and 3b show an end view of the siding and how the different types of batten strips are formed into the metal surface as protruding or reversed.

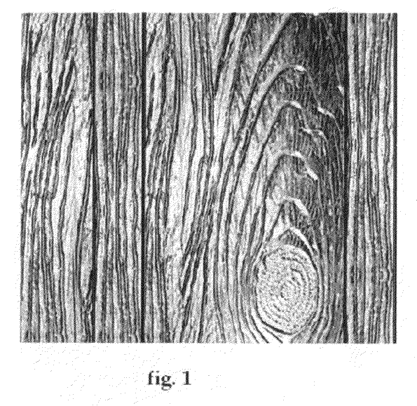

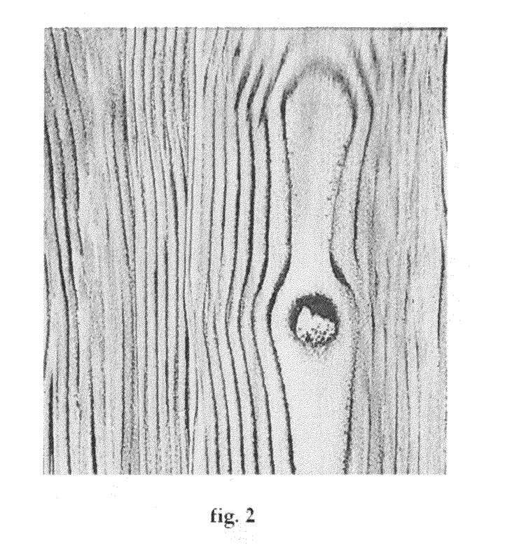

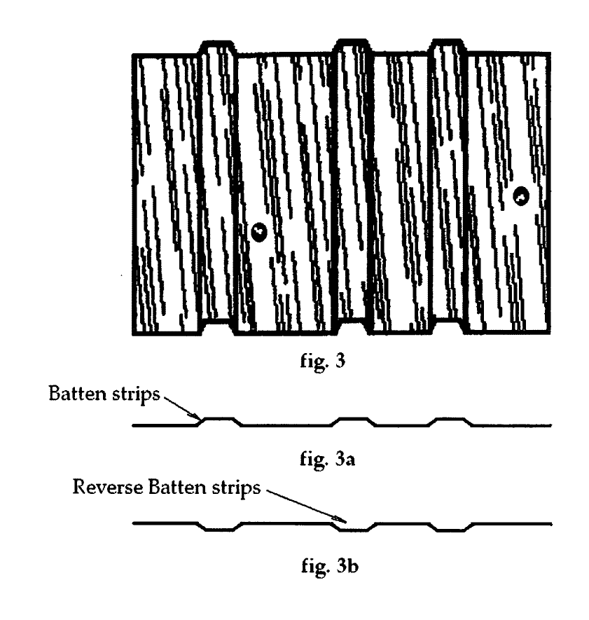

### DETAILED DESCRIPTION OF THE PREFERRED EMBODIMENTS

Detailed descriptions of the preferred embodiments are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

This new metal siding design, described as being used for the construction industry, can be made to resemble any wood surface desired by employing any means contrived to achieve a wood grain appearance for metal siding.

It is further stated that by changing the widths of the panels being used, a product can be created that further replicates the look of a real wood, board and batten siding. These panels can be distinguished by having batten strips that are raised, recessed or imprinted onto the surface of the materials. It is not required that these panels be of different widths for this invention, this is only stated as a further means of replicating old wood siding as it is.

It is also stated that any color or combination of colors can be used to accommodate a desired look for this invention no matter what the process of manufacture may involve.

While the invention has been described in connection with a preferred embodiment, it is not intended to limit the scope of the invention to the particular form set forth. On the contrary, it is intended to cover such alternatives, modifications, and equivalents as may be included within the spirit and scope of the invention as defined by the appended claims.

What is claimed is:

1. A Metal siding constructed to have an appearance comprising: a texture or look that is similar to that of a raised or lowered wood grain, either as a rough sawn lumber or having a weathered wood appearance, with or without knots.

2. The Metal siding of claim 1 further comprising: a means of which includes siding formed, stamped or indented to have batten strips, reverse or protruding at predetermined intervals, which resemble that of a wooden vertical plank siding.

3. The Metal siding of claim 1 further comprising: a means of which includes a wood grain affect which could be painted, screened, etched or overlaid onto the surface by any means practical to those skilled in the arts for the purpose of achieving the same result mentioned in claim 1.

4. The Metal siding of claim 1 further comprising: a means of which trim pieces can be created by these processes to further accent the metal siding as mentioned in claim 1.

5. The Metal siding of claim 1 further comprising: a means of which greater panel rigidity can be achieved from the grain design being stamped or raised into the panels of the siding mentioned in claim 1.
